(19) United States
(12) Patent Application Publication
(10) Pub. No.: US 2014/0237178 A1
(43) Pub. Date: Aug. 21, 2014

(54) STORAGE RESOURCE ACKNOWLEDGMENTS

(71) Applicant: Raju C. Bopardikar, Longmont, CO (US)

(72) Inventor: Raju C. Bopardikar, Longmont, CO (US)

(21) Appl. No.: 14/343,477

(22) PCT Filed: Sep. 29, 2011
(86) PCT No.: PCT/US2011/054011

§ 371 Date: Mar. 7, 2014

(51) Int. Cl. G06F 3/06

(52) U.S. Cl. CPC G06F 3/065; G06F 3/0604; G06F 3/0683
USPC 711/112; 711/154; 711/162

(57) ABSTRACT

A technique to adjust storage resource acknowledgments and a method thereof is Provided. In one aspect, a request for an operation associated with data is received, and it is determined whether the operation has attained a particular state. In a further aspect, the particular state is adjustable. In another example, the operation has reached the particular state, completion of the operation is acknowledged.

### BACKGROUND

Replication systems may be utilized to maintain the consistency of redundantly stored data. Such systems may store data redundantly on a plurality of storage resources to improve reliability and fault tolerance. Load balancing may be used to balance the replication among different computers in a cluster of computers. An application may initiate real-time data operations in each storage resource containing a copy of the redundantly stored data therein. Before proceeding to subsequent tasks, an application requesting a real-time data operation may wait idly by until it receives acknowledgement from each storage resource.

### BRIEF DESCRIPTION OF THE DRAWINGS

FIG. 1 illustrates a cluster of computers in accordance with aspects of the application.

FIG. 2 is a close up illustration of a pair of computer apparatus in accordance with aspects of the application.

FIG. 3 is an alternate configuration of the pair of computer apparatus in accordance with aspects of the application.

FIG. 4 is an illustrative arrangement of processes and storage devices in accordance with aspects of the application.

FIG. 5 illustrates a flow diagram in accordance with aspects of the application.

FIG. 6 is a working example of a data operation being acknowledged at different levels and an illustrative sequence diagram thereof.

FIG. 7 is a working example of a read operation and an illustrative sequence diagram thereof.

### DETAILED DESCRIPTION

Aspects of the disclosure provide a computer apparatus and method to enhance the performance of applications requesting real-time data operations on redundantly stored data. Rather than waiting for acknowledgments of completion from every storage resource, the application may proceed to subsequent tasks when an acknowledgment of completion is received from a number of storage resources. In one aspect, it may be determined whether the operation has attained a particular state. The particular state may represent a number of storage resources acknowledging completion of the operation therein. The particular state may be adjusted so as to adjust the number of acknowledging storage resources required to attain the particular state. If the operation has attained the particular state, completion of the operation may be acknowledged.

The aspects, features and advantages of the present disclosure will be appreciated when considered with reference to the following description of examples and accompanying figures. The following description does not limit the application; rather, the scope of the disclosure is defined by the appended claims and equivalents.

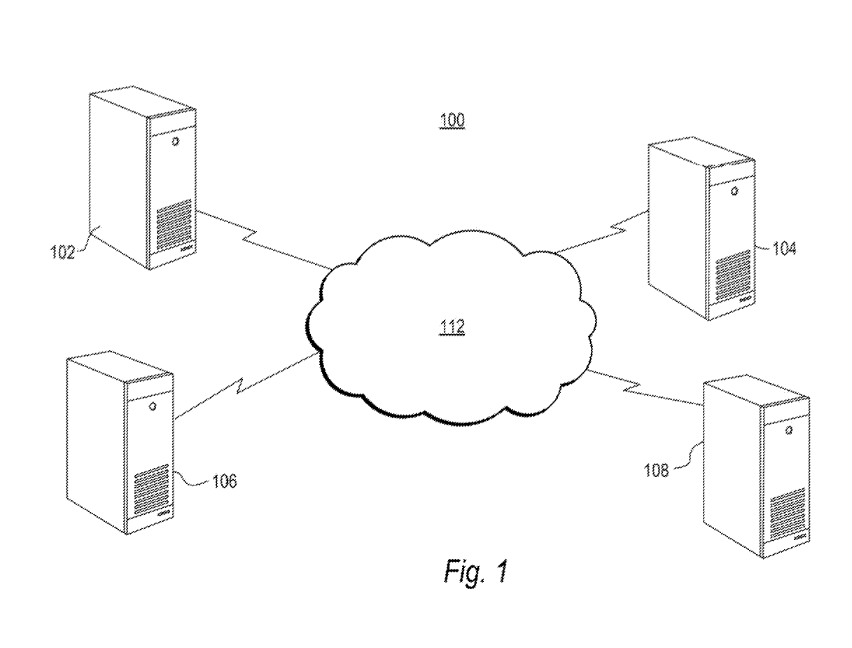

FIG. 1 presents a schematic diagram of an illustrative cluster 100 depicting various computing devices used in a networked configuration. For example, FIG. 1 illustrates a plurality of computers 102, 104, 106 and 108. Each computer may be a node of the cluster and may comprise any device capable of processing instructions and transmitting data to and from other computers, including a laptop, a full-sized personal computer, a high-end server, or a network computer lacking local storage capability.

The computers disclosed in FIG. 1 may be interconnected via a network 112, which may be a local area network (“LAN”), wide area network (“WAN”), the Internet, etc. Network 112 and intervening nodes may also use various protocols including virtual private networks, local Ethernet networks, private networks using communication protocols proprietary to one or more companies, cellular and wireless networks, HTTP, and various combinations of the foregoing. In addition, the intervening nodes of network 112 may utilize remote direct memory access (“RDMA”) to exchange information with the memory of a remote computer in the cluster. Although only a few computers are depicted in FIG. 1, it should be appreciated that a cluster may include additional interconnected computers. It should further be appreciated that cluster 100 may be an individual node in a network containing a larger number of computers.

As noted above, each computer shown in FIG. 1 may be at one node of cluster 100 and capable of directly or indirectly communicating with other computers or devices in the cluster. For example, computer 102 may be capable of using network 112 to transmit information to for example, computer 104. Accordingly, computer 102 may be used to replicate an operation associated with data, such as an input/output operation, to any one of the computers 104, 106, and 108. Cluster 100 may be arranged as a load balancing network such that computers 102, 104, 106, and 108 exchange information with each other for the purpose of receiving, processing, and replicating data. Computer apparatus 102, 104, 106, and 108 may include all the components normally used in connection with a computer. For example, they may have a keyboard, mouse, and/or various other types of input devices such as pen-inputs, joysticks, buttons, touch screens, etc., as well as a display, which could include, for instance, a CRT, LCD, plasma screen monitor, TV, projector, etc. In another example, they may have a graphics processing unit (“GPU”), redundant power supply, fans, and various input/output cards, such as Peripheral Component Interconnect (“PCI”) cards.

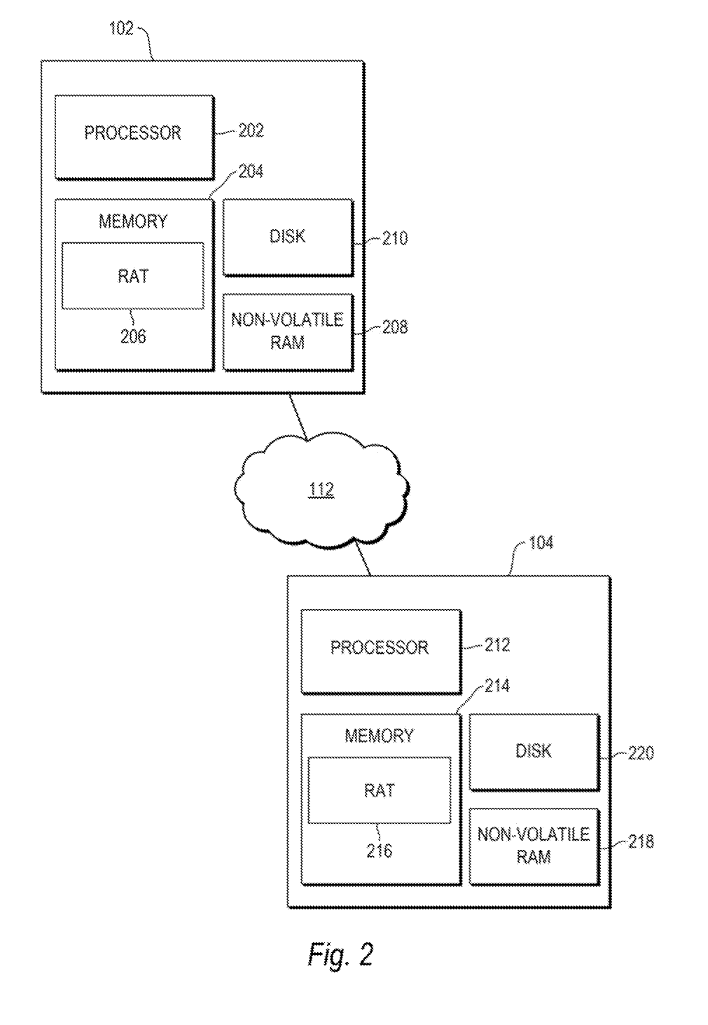

FIG. 2 presents a close up illustration of computer apparatus 102 and 104 depicting various components in accordance with aspects of the application. While the following examples and illustrations concentrate on communications between computer apparatus 102 and 104, it is understood that the examples herein may include additional computer apparatus and that computers 102 and 104 are featured merely for ease of illustration. Computer apparatus 102 and 104 may comprise processors 202 and 212 and memories 204 and 214 respectively. Memories 204 and 214 may store reflective access transfer instructions (“RAT driver”) 206 and 216. RAT drivers 206 and 216 may be retrieved and executed by their respective processors 202 and 212. The processors 202 and 212 may be any number of well known processors, such as processors from Intel® Corporation. Alternatively, the processors may be dedicated controllers for executing operations, such as an application specific integrated circuit (“ASIC”). In addition to processors 202 and 212, a remote maintenance processor may be used to monitor components of computer apparatus 102 and 104 for suspect conditions.

Memories 204 and 214 may be volatile random access memory (“RAM”) devices. The memories may be divided into multiple memory segments organized as dual memory modules (“DIMMs”). Computer apparatus 102 and 104 may also comprise non-volatile random access memory (“NVRAM”) devices 208 and 218, which may be any type of NVRAM, such as phase change memory (“PCM”), spin-torque transfer RAM (“STT-RAM”), or programmable permanent memory (e.g., flash memory). In addition, computers 102 and 104 may comprise disk storage 210 and 220, which may be floppy disk drives, tapes, hard disk drives, or other storage devices that may be coupled to computers 102 and 104 either directly or indirectly.

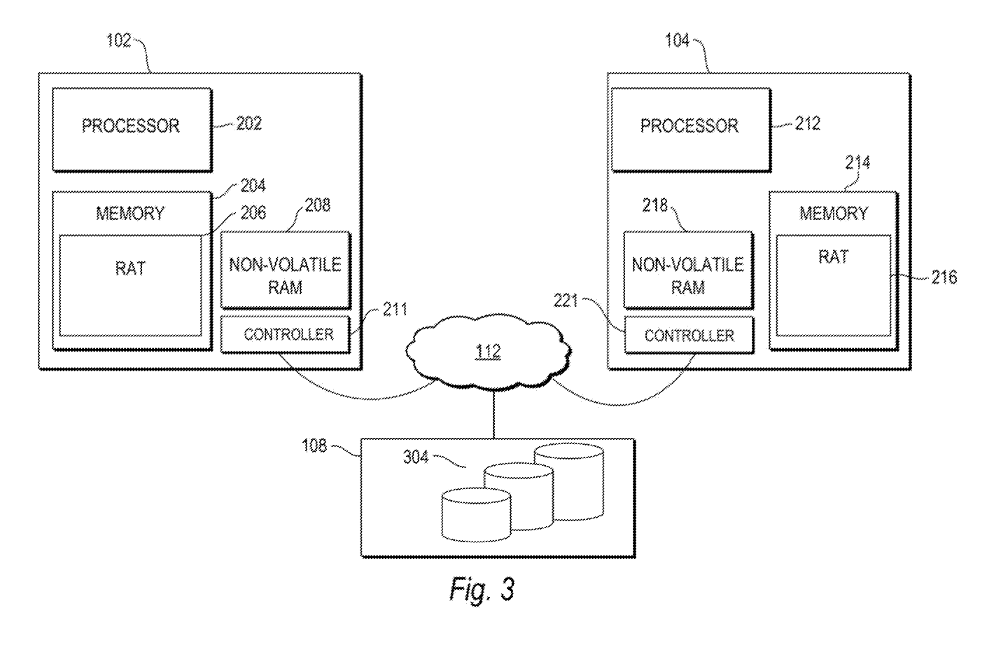

FIG. 3 illustrates an alternate arrangement in which computer apparatus 102 and 104 comprise disk controllers 211 and 221 in lieu of disk storage 210 and 220. Disk controllers 211 and 221 may be controllers for a redundant array of independent disks (“RAID”). Disk controllers 211 and 221 may be coupled to their respective computers via a host-side interface, such as fiber channel (“FC”), internet small computer system interface (“iSCSi”), or serial attached small computer system interface (“SAS”), which allows computer apparatus 102 and 104 to transmit one or more input/output requests to storage array 304. Disk controllers 211 and 221 may communicate with storage array 304 via a drive-side interface (e.g., FC, storage area network (“SAS”), network attached storage (“NAS”), etc.). Storage array 304 may be housed in, for example, computer apparatus 108. While FIG. 3 depicts disk controllers 211 and 221 in communication with storage array 304, it is understood that disk controllers 211 and 221 may sent input/output requests to separate storage arrays and that FIG. 3 is merely illustrative.

Although all the components of computer apparatus 102 and 104 are functionally illustrated as being within the same block, it will be understood that the components may or may not be stored within the same physical housing. Furthermore, each computer apparatus 102 and 104 may actually comprise multiple processors and memories working in tandem.

RAT drivers 206 and 216 may comprise any set of machine readable instructions to be executed directly (such as machine code) or indirectly (such as scripts) by the processor(s). The instructions of RAT drivers 206 and 216 may be stored in any computer language or format, such as in object code or modules of source code. The instructions may be stored in object code format for direct processing by the processor, or in any other computer language including scripts or collections of independent source code modules that are is on demand or compiled in advance. However, it will be appreciated that RAT drivers 206 and 216 may be realized in the form of software, hardware, or a combination of hardware and software.

In one example, the instructions of the RAT driver may be part of an installation package that may be executed by a processor, such as processors 202 and 212. In this example, the instructions may be stored in a portable medium such as a CD, DVD, or flash drive or a memory maintained by a server from which the installation package can be downloaded and installed. In another example, the instructions may be part of an application or applications already installed.

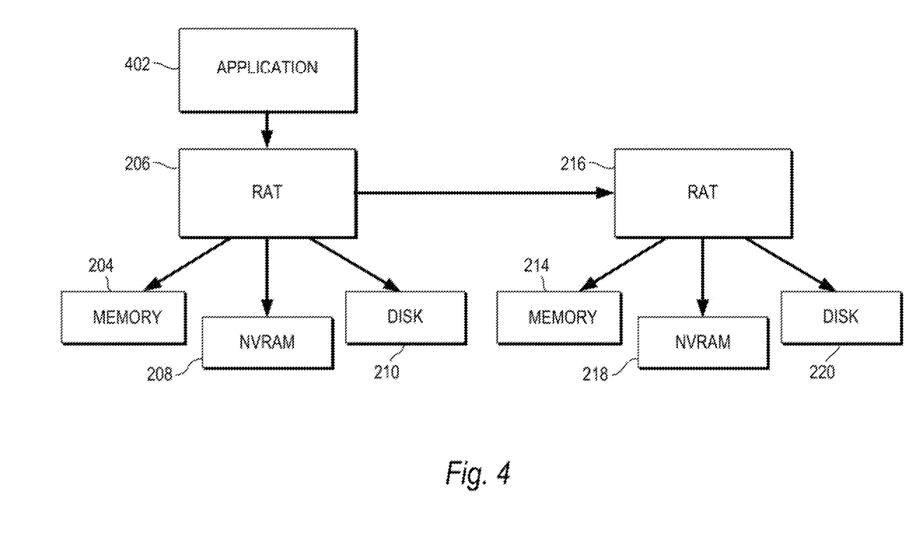

RAT drivers 206 or 216 may interface an application with the plurality of storage resources housed in computer apparatus 102 and 104. In addition, RAT drivers 206 and 216 may forward data operations to each other to allow the receiving RAT driver to replicate operations within its respective computer apparatus. FIG. 4 illustrates one possible arrangement of RAT drivers 206 and 216. Application 402, which may be a local application or an application from a remote computer, may transmit a request for an operation associated with date, such as an input/output operation, to RAT driver 206. RAT driver 206 may abstract the underlying storage resources that are utilized for data operations and replication. Once RAT driver 206 receives a request for a data operation, such as a write operation, RAT driver 206 may implement the operation in memory 204, NVRAM 208, and disk 210, resulting in consistent, redundant copies of the data. For additional backup, RAT driver 206 may transmit the request to RAT driver 216, which may replicate the data operation in memory 214, NVRAM 218, or disk 220.

Before proceeding to subsequent tasks, applications heretofore wait for acknowledgement of completion from all the storage resources housing redundant copies of the data. Conventionally, a data operation is considered complete when it has been implemented in all primary and secondary storage resources. However, the overall performance of an application may decrease considerably, since it must wait idly by until it receives acknowledgement from every storage resource (e.g., memories 204 and 214, NVRAM devices 208 and 218, and disks 210 and 220).

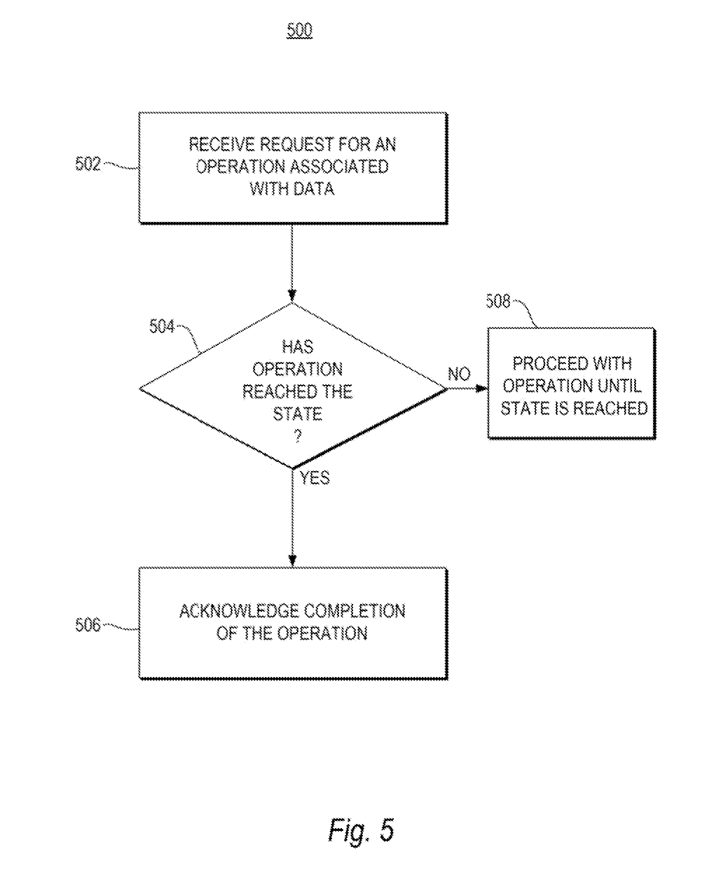

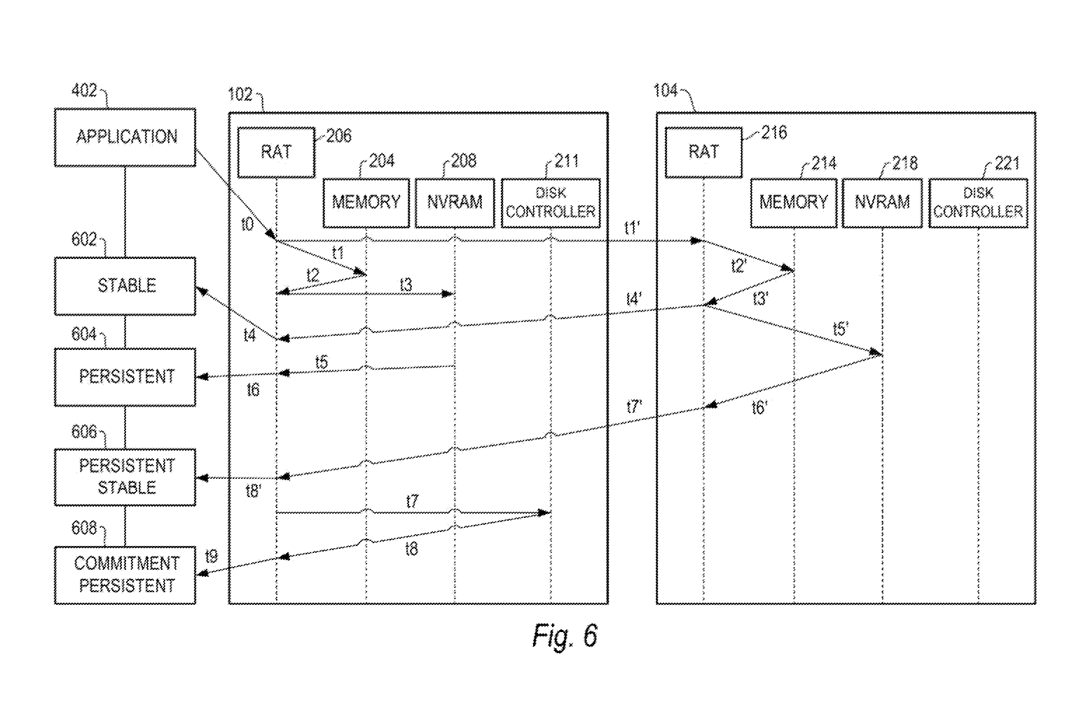

One working example of a system and method for reducing latency in applications utilizing data replication is shown in FIGS. 5-6. In particular, FIG. 5 illustrates a flow diagram of a process 500 for acknowledging completion of a data operation at different adjustable levels. FIG. 6 is an illustrative sequence diagram of a data operation replicated throughout a system. The actions shown in FIG. 6 will be discussed below with regard to the flow diagram of FIG. 5.

In block 502, a request for an operation associated with data may be received. This request may be received by RAT driver 206 or 216 from an application, such as application 402. In block 504, it may be determined whether the operation has reached a particular state. The particular state may represent a number of storage resources acknowledging completion of the operation therein. The particular state may be adjustable so as to adjust the number of acknowledging storage resources required to attain the particular state. Such adjustment may coincide with the particular needs of an application. FIG. 6 is a working example of a data operation acknowledged at adjustable levels. In the example of FIG. 6, RAT driver 206 or 216 may be configured to acknowledge completion of the operation when it attains the desired state. Such configuration may be implemented via, for example, a configuration file, a database, or even directly within the instructions of the RAT drivers.

As shown in FIG. 6, at time t0, application 402 of computer 102 may transmit a request to RAT driver 206 for an operation associated with data. In the example of 6, the operation is a write operation. At time t1, RAT driver 206 may write the data to memory 204 and may receive an acknowledgement therefrom at time t2. At time t1′, RAT driver 206 may transmit the write operation to RAT driver 216 to replicate the same in computer 104. At time t2′, in computer 104, RAT driver 216 may implement the write in memory 214 and may receive an acknowledgement therefrom at time t3′. RAT driver 216 may acknowledge completion of the write operation implemented in memory 214 and RAT driver 206 may receive the acknowledgment at time t4′.

Referring back to FIG. 5, if the operation teaches the desired state, the operation may be acknowledged, as shown in block 506. Otherwise, the operation may continue until the desired state is reached, as shown in block 508. In the example of FIG. 6, once RAT driver 206 receives acknowledgment confirming completion of the write operation in both memory 204 and memory 214, at times t2 and t4′ respectively, the status of the write operation may be considered to have attained a particular state, such as stable state 602. If so configured, RAT driver 206 may acknowledge completion of the write operation and application 402 may receive the acknowledgement at time t4. Stable status 602 may be reached when the write operation is known to have stored data in at least two separate memory devices. By way of example, application 402 may be a real time equity trading application that cannot afford to wait for acknowledgement from all the storage devices (e.g., NVRAM 208, NVRAM 218, storage array 304, etc.). Such application may benefit from receiving acknowledgment when the operation reaches a stable state 602. While application 402 may proceed to subsequent tasks when stable state 602 is attained, RAT drivers 206 and 216 may continue replicating the data operation to other storage resources.

Referring back to FIG. 6, at time t3, RAT driver 206 may implement the write in NVRAM device 208 and may receive acknowledgement therefrom at time t5. At this juncture, the write operation may be considered to have reached a persistent state 604. If so configured, RAT driver 206 may acknowledge completion of the write operation and application 402 may receive the acknowledgement at time t6. A persistent state 604 may be reached when the write operation is known to have stored a copy of the data in at least one persistent storage media device, such as NVRAM 208. Before proceeding to subsequent tasks, application 402 may be configured to wait only until the write operation reaches state 602 or 604.

In computer 104, at time t5′, RAT driver 216 may implement the write operation in NVRAM device 218 and may receive acknowledgement therefrom at time t6′. At time t7′, RAT driver 216 may forward this acknowledgment to RAT driver 206. At this juncture, the write operation may be considered to have reached a persistent-stable state 606. if so configured, RAT driver 206 may acknowledge completion of the write operation and application 402 may receive the acknowledgement at time t8′. The persistent-stable state 606 may be reached when the write operation is known to have stored a copy of the data in at least two persistent storage media devices, such as NVRAM 208 and 218. Before proceeding to subsequent tasks, application 402 may be configured to wait only until the write operation reaches state 602, 804, or 606.

In computer 102, RAT driver 206 may implement the write operation in storage array 204 via disk controller 211 at time t7 and may receive acknowledgement therefrom at time t8. At this juncture, the write operation may be considered to have reached a commitment-persistent state 608. If so configured, RAT driver 206 may acknowledge completion of the write operation and application 402 may receive the acknowledgement at time t9. The commitment-persistence state 608 may be attained when the write operation is known to have stored a copy of the data in at least one hard disk device, such as a volume in storage array 304. In another example, different acknowledgment levels may be configured for each volume of storage array 304. Before proceeding to subsequent tasks, application 402 may be configured to wait only until the write operation reaches state 602, 604, 606, or 608.

The examples disclosed above permit adjustment of a data operation's acknowledgement in order to tailor the acknowledgment to the specific needs of an application. Notwithstanding the desired acknowledgment level, the examples above permit data to be redundantly stored in additional storage resources after the desired acknowledgment level is reached, which improves reliability, fault tolerance, and accessibility. In another example, RAT drivers 206 and 216 may manage the consistency of the redundantly stored data. For example, if a data operation is a delete, the RAT drivers may ensure that the targeted data is deleted in every storage resource and may acknowledge completion of the deletion at the desired level of acknowledgement.

The examples disclosed above may be realized in any non-transitory computer-readable media for use by or in connection with an instruction execution system such as a computer/processor based system, an ASIC, or other system that can fetch or obtain the logic from non-transitory computer-readable media and execute the instructions contained therein. “Non transitory computer-readable media” can be any media that can contain, store, or maintain programs and data for use by or in connection with the instruction execution system. Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, or a portable compact disc.

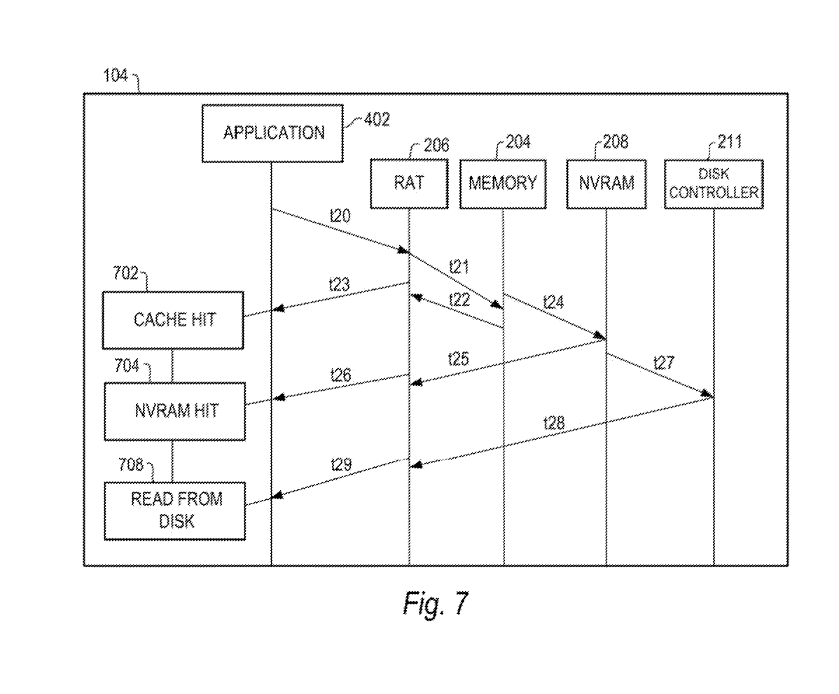

FIG. 7 illustrates the advantages of having redundant copies of data among various storage resources. In FIG. 7, application 402 submits a read request to RAT driver 206, at time 120. At time t21, RAT driver 206 may search the sought after data in memory 204 and may receive the data at time t22, if the data resides therein. Furthermore, if the data resides in memory 204, the read may result in a cache hit 702, and RAT driver 206 may transmit the data to application 402 at time t23. If the sought after data does not reside in memory 204, RAT driver 206 may search in NVRAM 208 at time t24. If the data resides in NVRAM 208, the data may be transmitted back to RAT driver 206 at time t25, and RAT driver 206 may forward the data to application 402 at time t26, which may result in NVRAM hit 704. If the sought after data does not reside in NVRAM 208, RAT driver 206 may search in storage array 304 via disk controller 211, at time t27. If the sought after data resides in storage array 304, the data may be transmitted back to RAT driver 206 at time t28, and RAT driver 206 may forward the data to application 402 at time t29, resulting in a read from disk 708.

Advantageously, the above-described apparatus and method allows an application to request a data operation and to receive varying levels of acknowledgement. At the same time, redundant copies of data may be maintained among a plurality of storage resources without diminishing the application's performance. In this regard, end users experience less latency, while fault-tolerance and reliability are improved.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein. Rather, various steps can be handled in a different order or simultaneously, and steps may be omitted or added.

1. A computer apparatus comprising:
a processor to:
receive a request for execution of an operation associated with data;
determine if the operation has attained a particular state, the particular state representing a number of storage resources aanowledging completion of the operation therein, the particular state being adjustable so as to adjust the number of acknowledging storage resources required to attain the particular state; and
if the operation has attained the particular state, acknowledge completion of the operation in response to the request.

2. The computer apparatus of claim 1, wherein the operation is a write operation.

3. The computer apparatus of claim 2, wherein the particular state is attained when the write operation stores a copy of the data in at least two separate memory devices.

4. The computer apparatus of claim 2, wherein the particular state is attained when the write operation stores a copy of the data in at least one persistent storage media device.

5. The computer apparatus of claim 2, wherein the particular state is attained when the write operation stores a copy of the data in at least two separate persistent storage media devices.

6. The computer apparatus of claim 2, wherein the particular state is attained when the write operation stores a copy of the data in at least one herd disk device.

7. A non-transitory computer readable medium having instructions stored therein which if executed cause a processor to:
receive a request for execution of an operation associated with data;
determine if the operation has attained a particular state, the particular state representing a number of storage resources acknowledging completion of the operation therein, the particular state being adjustable so as to adjust the number of acknowledging storage resources required to attain the particular state; and
if the operation has attained the particular state, acknowledge completion of the operation in response to the request.

8. The non-transitory computer readable medium of claim 7, wherein the operation is a write operation.

9. The non-transitory computer readable medium of claim 8, wherein the particular state is attained when the write operation stores a copy of the data at least two separate memory devices.

10. The non-transitory computer readable medium of claim 8, wherein the particular state is attained when the write operation stores a copy of the data in at least one persistent storage media device.

11. The non-transitory computer readable medium of claim 8, wherein the particular state is attained when the write operation stores a copy of the data in at least two separate persistent storage media devices.

12. The non-transitory computer readable medium of claim 8, wherein the particular state is attained when the write operation stores a copy of the data in at least one hard disk device.

13. A method comprising:
receiving a request from an application for execution of a write operation;
initiating execution of the write operation in a plurality of storage resources:
determining if the write operation has attained a particular state, the particular state representing a number of storage resources that acknowledged completion of the write operation therein, the particular state being adjustable so as to adjust the number of acknowledging storage resources required to attain the particular state;
if the write operation has attained the particular state, transmitting an acknowledgment confirming completion of the write operation so as to allow the application to proceed to subsequent tasks; and
initiating execution of the write operation in additional storage resources different than the plurality of storage resources.

14. The method of claim 3, wherein the particular state is attained when the write operation stores a copy of data in at least two separate memory devices or when the write operation stores the copy of data in at least one persistent storage media device.

15. The method of claim 13, wherein the particular state is attained when the write operation stores a copy of data in at least two separate persistent storage media devices or when the write operation stores the copy of data in at least one hard disk device.
